(19) United States
(12) Patent Application Publication
(10) Pub. No.: US 2025/0180784 A1
(43) Pub. Date: Jun. 5, 2025

(54) DIELECTRIC MULTILAYER FILM-EQUIPPED SUBSTRATE AND METHOD FOR MANUFACTURING SAME

(71) Applicant: AGC Inc., Tokyo (JP)

(72) Inventors: Hideaki TAKAHOSHI, Tokyo (JP); Tomoyuki Arae, Tokyo (JP); Yasuhisa Nishikawa, Tokyo (JP); Teruo Fujiwara, Tokyo (JP)

(73) Assignee: AGC Inc., Tokyo (JP)

(21) Appl. No.: 19/046,758

(22) Filed: Feb. 6, 2025

Related U.S. Application Data
(63) Continuation of application No. PCT/JP2023/029281, filed on Aug. 10, 2023.

(30) Foreign Application Priority Data
Aug. 24, 2022 (JP) 2022-133627

(51) Int. Cl. G02B 1/115; C03C 17/34

(52) U.S. Cl. CPC G02B 1/115; C03C 17/3417; C03C 2217/212; C03C 2217/213; C03C 2217/228; C03C 2217/734; C03C 2218/156

(57) ABSTRACT

A dielectric multilayer film-attached substrate including a substrate and a dielectric multilayer film provided thereon, in which the dielectric multilayer film includes a first dielectric laminated film and a second dielectric laminated film laminated in this order from a substrate side, the first dielectric laminated film includes a first high refractive index film layer containing TiO₂ and a first low refractive index film layer containing SiO₂ laminated alternately in this order from the substrate side with an equal number, the second dielectric laminated film includes a second high refractive index film layer containing Ta₂O₅ or Nb₂O₅ and a second low refractive index film layer containing SiO₂ laminated alternately in this order from the substrate side with an equal number, and a first low refractive index film layer located farthest from the substrate in the first dielectric laminated film has a thickness of 30 nm or more.

### CROSS-REFERENCE TO RELATED APPLICATIONS

This is a bypass continuation of International Application No. PCT/JP2023/029281 filed on Aug. 10, 2023, and claims priority from Japanese Patent Application No. 2022-133627 filed on Aug. 24, 2022, the entire content of which is incorporated herein by reference.

### TECHNICAL FIELD

The present invention relates to a dielectric multilayer film-attached substrate and a production method therefor.

### BACKGROUND ART

There are many known techniques of providing a dielectric multilayer film on a front surface of an optical device to obtain desired properties.

For example, Patent Literature 1 below discloses a configuration including a dielectric multilayer film on a substrate, in which the dielectric multilayer film has, from a surface, a plurality of low refractive index layers, high refractive index layers, and anti-reflection layers.

Patent Literature 2 below discloses an optical filter member including a light transmitting film including a plurality of first dielectric layers made of silicon oxide and a plurality of second dielectric layers made of titanium oxide on a surface of a substrate made of a light transmitting material.

Patent Literature 3 below discloses an optical article including, on a substrate, an inorganic thin film having a plurality of layers, in which the inorganic thin film is formed by laminating a plurality of silicon oxide layers and a plurality of metal oxide layers, the metal oxide is a metal oxide containing at least one of zirconium, tantalum, and titanium, and the inorganic thin film has a surface roughness of 0.55 nm or more and 0.70 nm or less.

Patent Literature 4 below discloses a visible light mirror including, on a substrate, a mirror stack layer portion including a layer of a dielectric material formed by alternatively laminating Ta₂O₅ and SiO₂.

Patent Literature 5 below discloses a polarizing beam splitter in which a high refractive index dielectric film made of a high refractive index material and a low refractive index dielectric film made of a low refractive index material are alternately laminated on a substrate, and examples of the high refractive index dielectric film include Ta₂O₅, TiO₂, HfO₂, ZrO₂, LaTi_{X}O_{Y}, and Y₂O₃, and examples of the low refractive index dielectric film include SiO₂ and MgF₂.

Patent Literature 6 below discloses an anti-reflection film made of a multilayer film with a total of 14 to 17 layers based on alternating layers of TiO₂ and SiO₂ films on a substrate surface from a substrate side to an air side.

### CITATION LIST

### Patent Literature

Patent Literature 1: WO2021/111813
Patent Literature 2: JP2018-25732A
Patent Literature 3: JP2012-118536A
Patent Literature 4: JP2010-26030A
Patent Literature 5: JP2003-114326A
Patent Literature 6: JP2002-14203A

### SUMMARY OF INVENTION

### Technical Problem

On the other hand, there is also a known technique in which a transparent anti-reflection film having a dielectric multilayer film is provided on a front surface of an image display device in order to prevent external light from being glared on a screen. However, in the related techniques, in the case where a dielectric multilayer film is formed on a substrate by sputtering (see the above Patent Literatures 1, 2, 5, and 6), the obtained dielectric multilayer film has a problem that a residual stress of the film is high, which may cause warpage or peeling. In particular, since the transparent anti-reflection film is formed on a cover glass or film, reducing the film stress is important for stabilizing properties over a long period of time.

Therefore, an object of the present invention is to provide a dielectric multilayer film-attached substrate having a reduced film stress and a production method therefor.

### Solution to Problem

The present invention is as follows.
(1) A dielectric multilayer film-attached substrate including a substrate and a dielectric multilayer film provided on the substrate, in which
the dielectric multilayer film includes a first dielectric laminated film and a second dielectric laminated film which are laminated in this order from a substrate side,
the first dielectric laminated film includes a first high refractive index film layer containing TiO₂ and a first low refractive index film layer containing SiO₂ which are alternately laminated in this order from the substrate side with an equal number,
the second dielectric laminated film includes a second high refractive index film layer containing Ta₂O₅ or Nb₂O₅ and a second low refractive index film layer containing SiO₂ which are alternately laminated in this order from the substrate side with an equal number, and
a first low refractive index film layer located farthest from the substrate in the first dielectric laminated film has a thickness of 30 nm or more.
(2) The dielectric multilayer film-attached substrate according to the above (1), in which a ratio ( T1/T2) is 0.7 or more and 1.4 or less, provided that T1 is a thickness of a first high refractive index film layer located farthest from the substrate in the first dielectric laminated film and T2 is a thickness of a second high refractive index film layer located closest to the substrate side in the second dielectric laminated film.
(3) The dielectric multilayer film-attached substrate according to the above (1) or (2), in which the dielectric multilayer film has a total thickness of 300 nm or less.

1(4) The dielectric multilayer film-attached substrate according to the above (1) or (2), in which a second low refractive index film layer located farthest from the substrate in the second dielectric laminated film has a thickness of 75 nm or more and 105 nm or less.
(5) The dielectric multilayer film-attached substrate according to the above (1) or (2), in which a total number of layers of the first high refractive index film layer, the first low refractive index film layer, the second high refractive index film layer, and the second low refractive index film layer in the dielectric multilayer film is 6 or more and 12 or less.
(6) The dielectric multilayer film-attached substrate according to the above (5), in which the total number of layers is 6.
(7) The dielectric multilayer film-attached substrate according to the above (6), in which the dielectric multilayer film includes, from the substrate side:
a first high refractive index film layer a1 containing TiO₂;
a first low refractive index film layer b1 containing SiO₂;
a first high refractive index film layer a2 containing TiO₂;
a first low refractive index film layer b2 containing SiO₂;
a second high refractive index film layer a3 containing Ta₂O₅ or Nb₂O₅; and
a second low refractive index film layer b3 containing SiO₂.
(8) The dielectric multilayer film-attached substrate according to the above (6), in which the dielectric multilayer film includes, from the substrate side:
a first high refractive index film layer a1 containing TiO₂ and having a thickness of 20 nm or less;
a first low refractive index film layer b1 containing SiO₂ and having a thickness of 30 nm or more and 50 nm or less;
a first high refractive index film layer a2 containing TiO₂ and having a thickness of 10 nm or more and 50 nm or less;
a first low refractive index film layer b2 containing SiO₂ and having a thickness of 30 nm or more and 50 nm or less;
a second high refractive index film layer a3 containing Ta₂O₅ or Nb₂O₅ and having a thickness of 15 nm or more and 50 nm or less; and
a second low refractive index film layer b3 containing SiO₂ and having a thickness of 75 nm or more and 105 nm or less.
(9) The dielectric multilayer film-attached substrate according to the above (1) or (2), in which the substrate includes at least one of a glass and a resin.
(10) The dielectric multilayer film-attached substrate according to the above (1) or (2), further including an adhesion layer between the substrate and the dielectric multilayer film.
(11) A method for producing a dielectric multilayer film-attached substrate,
a dielectric multilayer film-attached substrate including:
a substrate; and
a dielectric multilayer film provided on the substrate and including a first dielectric laminated film and a second dielectric laminated film,
the method including:
alternately laminating an equal number of a first high refractive index film layer containing TiO₂ and a first low refractive index film layer containing SiO₂ in this order on the substrate to form a first dielectric laminated film; and
alternately laminating an equal number of a second high refractive index film layer containing Ta₂O₅ or Nb₂O₅ and a second low refractive index film layer containing SiO₂ in this order on the first dielectric laminated film to form a second dielectric laminated film, in which
a first low refractive index film layer located farthest from the substrate in the first dielectric laminated film has a thickness of 30 nm or more.

### Advantageous Effects of Invention

According to one aspect of the present invention, it is possible to provide a dielectric multilayer film-attached substrate having a reduced film stress and a production method therefor.

### BRIEF DESCRIPTION OF DRAWINGS

FIG. 1 is a cross-sectional view schematically showing a configuration example of a dielectric multilayer film-attached substrate according to an embodiment of the present invention.

FIG. 2 is a cross-sectional view schematically showing a particularly preferred configuration example of the dielectric multilayer film-attached substrate according to the embodiment of the present invention.

FIG. 3 is a graph showing a thickness of a dielectric multilayer film prepared in Examples.

FIG. 4 is a graph showing a film stress of the dielectric multilayer film prepared in Examples.

### DESCRIPTION OF EMBODIMENTS

Hereinafter, an embodiment of the present invention is described.

Note that, in the present description, a phrase “another layer, film, or the like being provided on a main surface of a substrate or on a film such as a dielectric multilayer film” is not limited to an embodiment in which the another layer, film, or the like is provided in contact with the main surface, layer, or film, but may be an embodiment in which the another layer, film, or the like is provided in an upward direction.

### Dielectric Multilayer Film-Attached Substrate

First, a configuration of a dielectric multilayer film-attached substrate according to an embodiment of the present invention is described.

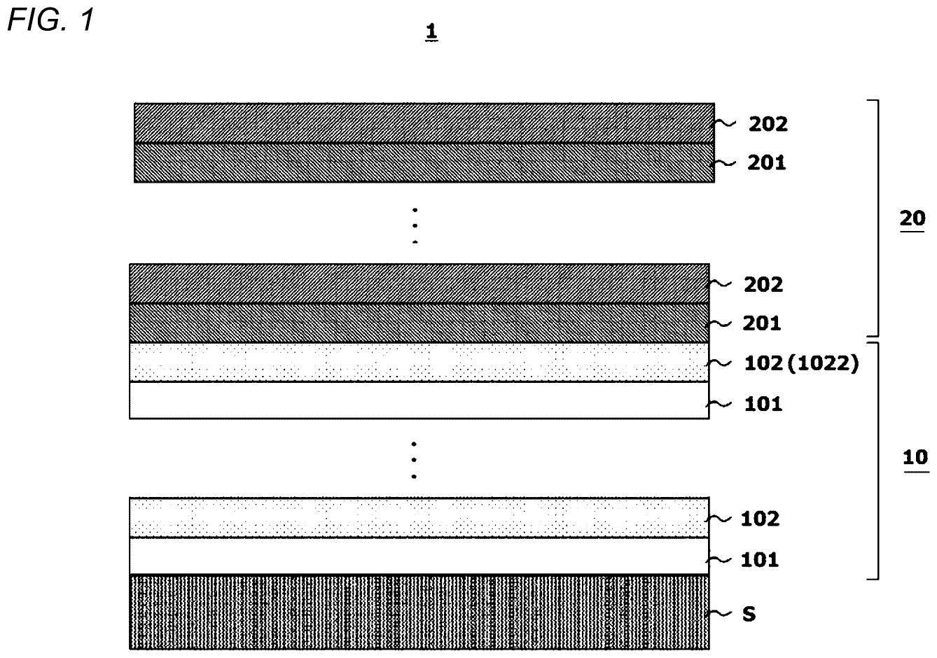

FIG. 1 is a cross-sectional view schematically showing a configuration example of the dielectric multilayer film-attached substrate according to the embodiment of the present invention.

The dielectric multilayer film is formed by laminating a first dielectric laminated film 10 and a second dielectric laminated film 20 in this order on a substrate S. In other words, the dielectric multilayer film includes, on the substrate S, a first portion made of the first dielectric laminated film 10 and a second portion made of the second dielectric laminated film 20 in this order.

The first dielectric laminated film 10 is formed by alternately laminating a first high refractive index film layer 101 containing TiO₂ and a first low refractive index film layer 102 containing SiO₂ in this order from a substrate S side, and this alternating lamination can be repeated a plurality of times. The first dielectric laminated film 10 has the same number of first high refractive index film layers 101 and first low refractive index film layers 102.

Note that, in the present description, a high refractive index film layer means a dielectric film having a refractive index higher than a refractive index of the substrate, and a low refractive index film layer means a dielectric film having a refractive index lower than that of the high refractive index layer.

The second dielectric laminated film 20 is formed by alternately laminating a second high refractive index film layer 201 containing Ta₂O₅ or Nb₂O₅ and a second low refractive index film layer 202 containing SiO₂ in this order from the substrate S side, and this alternating lamination can be repeated a plurality of times. The second dielectric laminated film 20 has the same number of second high refractive index film layers 201 and second low refractive index film layers 202.

In the first dielectric laminated film 10, a first low refractive index film layer 1022 located farthest from the substrate S has a thickness of 30 nm or more.

Considering the dielectric multilayer film as a whole, the dielectric multilayer film is formed by alternately laminating an equal number of high refractive index film layers and low refractive index film layers in this order from the substrate S side. In addition, when viewed from the substrate S side, the first layer is a high refractive index film layer and the final layer is a low refractive index film layer, which reduces a film stress of the dielectric multilayer film and also reduces a luminous reflectance (SCI Y) to be described later.

In the present embodiment, the first high refractive index film layer 101 may contain a high refractive index material other than TiO₂. In this case, a high refractive index material having a film stress higher than that of Ta₂O₅ and Nb₂O₅ is preferred. However, from the viewpoint of achieving the effects of the present invention, the first high refractive index film layer 101 does not contain Ta₂O₅ or Nb₂O₅. That is, the first dielectric laminated film 10 does not include the “second high refractive index film layer 201 containing Ta₂O₅ or Nb₂O₅”.

Similarly, the second high refractive index film layer 201 may contain a high refractive index material other than Ta₂O₅ or Nb₂O₅. In this case, a high refractive index material having a film stress lower than that of TiO₂ is preferred. However, from the viewpoint of achieving the effects of the present invention, the second high refractive index film layer 201 does not contain TiO₂. That is, the second dielectric laminated film 20 does not include the “first high refractive index film layer 101 containing TiO₂”.

As described above, the first dielectric laminated film 10 is formed by alternately laminating the first high refractive index film layer 101 containing TiO₂ and the first low refractive index film layer 102 containing SiO₂ in this order from the substrate S side. In addition, the second dielectric laminated film 20 is formed by alternately laminating the second high refractive index film layer 201 containing Ta₂O₅ or Nb₂O₅ and the second low refractive index film layer 202 containing SiO₂ in this order from the substrate S side.

In the dielectric multilayer film, a total number of layers of the first high refractive index film layer, the first low refractive index film layer, the second high refractive index film layer, and the second low refractive index film layer is preferably 4 or more and 12 or less, from the viewpoint of further reducing the film stress of the dielectric multilayer film. In addition, the total number of layers is more preferably 4 or more, still more preferably 6 or more, and is more preferably 10 or less, still more preferably 8 or less. The total number of layers is particularly preferably 6.

In the first dielectric laminated film 10, a total number of layers of the first high refractive index film layer 101 and the first low refractive index film layer 102 is preferably 2 or more and 8 or less, from the viewpoint of further reducing the film stress of the dielectric multilayer film. In addition, the total number of layers is more preferably 2 or more and more preferably 6 or less. The total number of layers is particularly preferably 4.

In the second dielectric laminated film 20, a total number of layers of the second high refractive index film layer 201 and the second low refractive index film layer 202 is preferably 2 or more and 8 or less, from the viewpoint of further reducing the film stress of the dielectric multilayer film. In addition, the total number of layers is more preferably 2 or more, and is more preferably 8 or less, still more preferably 6 or less, and even more preferably 4 or less. The total number of layers is particularly preferably 2.

In the dielectric multilayer film-attached substrate according to the embodiment of the present invention, the first low refractive index film layer 102 (1022) located farthest from the substrate S in the first dielectric laminated film 10 has a thickness of 30 nm or more. The thickness is preferably 30 nm or more and 50 nm or less, from the viewpoint of further reducing the film stress of the dielectric multilayer film. The thickness is more preferably 45 nm or less, and still more preferably 40 nm or less.

Note that, a phrase “first low refractive index film layer located farthest from the substrate S” means, in other words, “the first low refractive index film layer in contact with the second dielectric laminated film”.

In the present description, the refractive index and the thickness that can reproduce a reflection spectrum can be calculated from the actual reflection spectrum by using a refractive index dispersion and the thickness as variables by a computer. The above can be carried out using commercially available software, for example, TF-Calc (manufactured by HULINKS Inc.) or OptiLayer (manufactured by Caywan Office Inc.). It is also possible to estimate the thickness by observing a cross-sectional structure using a scanning electron microscope and measuring the thickness of layers with different contrast. In this case, since the resolution is important, it is preferable to perform the measurement at a viewing angle where the entire laminated structure can be observed, and to use an average of measurements at a plurality of points or more. It is more preferable to use an average of five or more measurements.

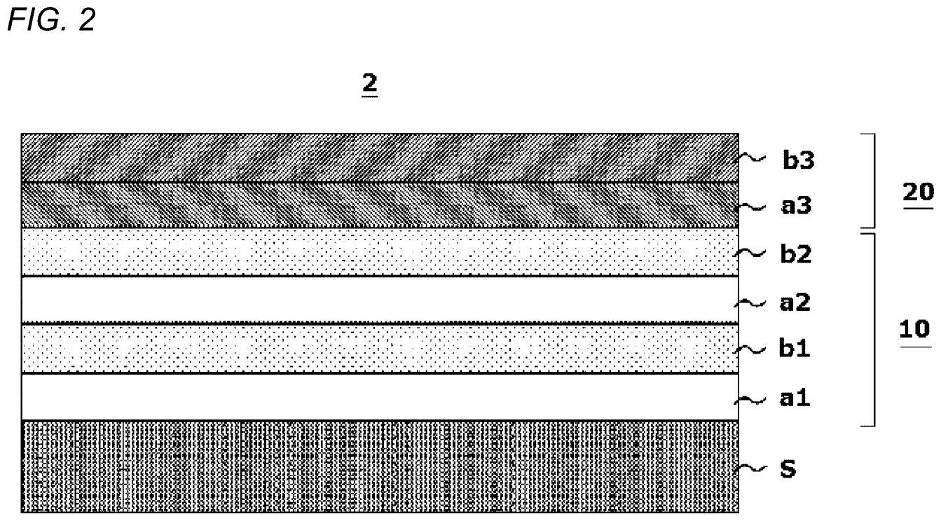

In addition, the second low refractive index film layer located farthest from the substrate S in the second dielectric laminated film 20 (a low refractive index film layer b3 in an embodiment shown in FIG. 2 to be described later) preferably has a thickness of 75 nm or more and 105 nm or less, from the viewpoint of further reducing the film stress of the dielectric multilayer film. The thickness is more preferably 80 nm or more, and is more preferably 100 nm or less, still more preferably 95 nm or less.

In addition, a ratio (T1/T2) is preferably 0.7 or more and 1.4 or less, from the viewpoint of further reducing the film stress of the dielectric multilayer film, where T1 is a thickness of the first high refractive index film layer located farthest from the substrate S in the first dielectric laminated film 10 (a high refractive index film layer a2 in the embodiment shown in FIG. 2 to be described later), and T2 is a thickness of the second high refractive index film layer located closest to the substrate side in the second dielectric laminated film (a high refractive index film layer a3 in the embodiment shown in FIG. 2 to be described later). The ratio (T1/T2) is more preferably 1 or more, still more preferably 1.2 or more, and even more preferably 1.3 or more.

In vacuum deposition for forming a dielectric multilayer film or the like, an increase in number of layers or film thickness increases the production time, leading to an increase in production cost. The total thickness of the dielectric multilayer film is preferably 300 nm or less, and more preferably 250 nm or less, from the viewpoint of reducing the production cost.

In the present embodiment, the reason why the film stress of the dielectric multilayer film is reduced is not clear, but the following reason is presumed. That is, an internal stress of a dielectric film changes depending on a gas pressure during film formation, and from the viewpoint of denseness of the film, it is necessary to lower the pressure of a sputtering gas (generally Ar) during film formation. However, since the film is generally formed at a pressure of about 0.1 Pa, residual stress components after film formation are compressive within the film surface. Therefore, the dielectric film basically has a compressive stress, and the magnitude of the stress varies depending on the kind of material. When a material having a large compressive stress is laminated on a material having a small compressive stress, a stress difference is applied in an action-reaction manner. Therefore, a stress having the opposite sign is applied to the film interface, and the stress in the entire laminated film is reduced. Such an effect is further enhanced by using a combination of a plurality of materials for the dielectric film. Therefore, according to the present embodiment, when a first high refractive index film layer containing TiO₂ having a high compressive stress is provided on the substrate side and a second high refractive index film layer containing Ta₂O₅ or Nb₂O₅ having a low compressive stress is laminated in a direction away from the substrate in a high refractive index film layer, the film stress of the dielectric multilayer film is presumed to be reduced. Note that, the present invention is not limited in any way for this reason.

FIG. 2 is a cross-sectional view schematically showing a configuration example of the dielectric multilayer film-attached substrate according to the above particularly preferred embodiment of the present invention.

In FIG. 2, a dielectric multilayer film-attached substrate 2 is formed by laminating the first dielectric laminated film 10 and the second dielectric laminated film 20 in this order on the substrate S, and the first dielectric laminated film 10 is formed by laminating a first high refractive index film layer a1 containing TiO₂, a first low refractive index film layer b1 containing SiO₂, a first high refractive index film layer a2 containing TiO₂, and a first low refractive index film layer b2 containing SiO₂ in this order from the substrate S side.

The second dielectric laminated film 20 is formed by laminating the second high refractive index film layer a3 containing Ta₂O₅ or Nb₂O₅ and the second low refractive index film layer b3 containing SiO₂ in this order from the substrate S side.

In the first dielectric laminated film 10, the first low refractive index film layer b2 located farthest from the substrate S has a thickness of 30 nm or more.

The dielectric multilayer film-attached substrate 2 shown in FIG. 2 has a dielectric laminated film having a total of six layers provided on the substrate S. The embodiment shown in FIG. 2 is particularly preferred from the viewpoint of further reducing the film stress of the dielectric multilayer film and reducing the luminous reflectance (SCI Y).

In the embodiment shown in FIG. 2, a thickness of the first high refractive index film layer a1 containing TiO₂ is preferably 20 nm or less, and more preferably 3 nm or more and 15 nm or less. The thickness of the first high refractive index film layer a1 is more preferably 10 nm or less.

A thickness of the first low refractive index film layer b1 containing SiO₂ is preferably 30 nm or more and 50 nm or less. The thickness of the first low refractive index film layer b1 is more preferably 35 nm or more, and is more preferably 45 nm or less, still more preferably 40 nm or less.

A thickness of the first high refractive index film layer a2 containing TiO₂ is preferably 10 nm or more and 50 nm or less. The thickness of the first high refractive index film layer a2 is more preferably 15 nm or more, still more preferably 20 nm or more, and is more preferably 45 nm or less, still more preferably 40 nm or less.

A thickness of the first low refractive index film layer b2 containing SiO₂ is preferably 30 nm or more and 50 nm or less. The thickness of the first low refractive index film layer b2 is preferably 30 nm or more, and is preferably 50 nm or less, more preferably 45 nm or less, and still more preferably 40 nm or less. Note that, the first low refractive index film layer b2 containing SiO₂ corresponds to the first low refractive index film layer located farthest from the substrate.

A thickness of the second high refractive index film layer a3 containing Ta₂O₅ or Nb₂O₅ is preferably 15 nm or more and 50 nm or less. The thickness of the second high refractive index film layer a3 is more preferably 20 nm or more, still more preferably 30 nm or more, and is more preferably 45 nm or less, still more preferably 40 nm or less.

A thickness of the second low refractive index film layer b3 containing SiO₂ is preferably 75 nm or more and 105 nm or less. The thickness of the second low refractive index film layer b3 is more preferably 80 nm or more, and is more preferably 100 nm or less, still more preferably 95 nm or less.

### Substrate

The substrate in the present embodiment may be any known substrate such as a glass or a resin film. In the case where the dielectric multilayer film-attached substrate according to the present embodiment is used as an anti-reflection film, the substrate preferably has a refractive index of 1.4 or more and 1.7 or less. When the refractive index of the substrate is within the above range, reflection at an adhesion surface can be sufficiently prevented in the case of optically adhering a display, a touch panel, or the like. The refractive index of the substrate is more preferably 1.45 or more, still more preferably 1.47 or more, and is more preferably 1.65 or less, still more preferably 1.6 or less.

The substrate preferably includes at least one of a glass and a resin.

In the case where the substrate includes a glass, the kind of the glass is not particularly limited, and glasses having various compositions can be used. Among them, the glass preferably contains quartz or sodium and preferably has a composition that allows molding and strengthening by a chemical strengthening treatment. Specific examples thereof include a quartz glass, an aluminosilicate glass, a soda lime glass, a borosilicate glass, an alkali-free glass, a lead glass, an alkali barium glass, and an aluminoborosilicate glass. Note that, in the present description, in the case where the substrate includes a glass, the substrate is also called a glass substrate.

A thickness of the glass substrate is not particularly limited, and is generally preferably 5 mm or less, more preferably 3 mm or less, and still more preferably 1.5 mm or less. The thickness is generally 0.2 mm or more.

The glass substrate is preferably a chemically strengthened glass obtained by chemical strengthening. Accordingly, the strength of the dielectric multilayer film-attached substrate is increased. Note that, in the case where an anti-glare layer to be described later is provided on the glass substrate, the chemical strengthening is carried out after the anti-glare layer is provided and before the dielectric multilayer film (multilayer film) is formed.

In the case where the substrate includes a resin, the kind of the resin is not particularly limited, and resins having various compositions can be used. Among them, the resin is preferably a thermoplastic resin or a thermosetting resin. Examples thereof include a polyvinyl chloride resin, a polyethylene resin, a polypropylene resin, a polystyrene resin, a polyvinyl acetate resin, a polyester resin, a polyurethane resin, a cellulose-based resin, an acrylic resin, an AS (acrylonitrile-styrene) resin, an ABS (acrylonitrile-butadiene-styrene) resin, a fluorine-based resin, a thermoplastic elastomer, a polyamide resin, a polyimide resin, a polyacetal resin, a polycarbonate resin, a modified polyphenylene ether resin, a polyethylene terephthalate resin, a polybutylene terephthalate resin, a polylactic acid-based resin, a cyclic polyolefin resin, and a polyphenylene sulfide resin. Among them, a cellulose-based resin is preferred, and examples thereof include a triacetyl cellulose resin, a polycarbonate resin, and a polyethylene terephthalate resin. These resins may be used alone or in combination of two or more kinds thereof. The resin particularly preferably contains at least one resin selected from polyethylene terephthalate, a polycarbonate, acryl, silicone, and triacetyl cellulose.

Note that, in the present description, in the case where the substrate includes a resin, the substrate is also called a resin substrate.

The shape of the resin substrate is not particularly limited. Examples thereof include a film shape or a plate shape, and a film shape is preferred from the viewpoint of shatter-resistance. In the case where the resin substrate has a film shape, that is, when it is a resin film, the thickness is not particularly limited, and is preferably 20 μm to 250 μm, and more preferably 40 μm to 188 μm. In the case where the resin substrate has a plate shape, that is, when it is a resin plate, the thickness is not particularly limited, and is preferably generally 5 mm or less, more preferably 3 mm or less, and still more preferably 1.5 mm or less. It is generally 0.2 mm or more.

In the case where the transparent substrate includes both a glass and a resin, for example, the resin substrate may be provided on the glass substrate.

### Adhesion Layer

In the present invention, an adhesion layer can also be provided between the substrate and the dielectric multilayer film.

The kind of the adhesion layer is not particularly limited, and may be an organic layer made of a resin or the like, or an inorganic layer. Hereinafter, each case is described in detail.

### Organic Layer

The organic layer is preferably a resin layer containing a predetermined resin. The kind of the resin forming the resin layer is not particularly limited, and examples thereof include a silicone resin, a polyimide resin, an acrylic resin, a polyolefin resin, a polyurethane resin, and a fluorine-based resin. Several kinds of resins may also be mixed to be used. Among them, a silicone resin, a polyimide resin, and a fluorine-based resin are preferred.

A thickness of the organic layer is not particularly limited, and is preferably 1 μm to 100 μm, more preferably 5 μm to 30 μm, and still more preferably 7 μm to 20 μm. When the thickness of the organic layer is within the above range, the adhesion between the substrate and the dielectric multilayer film is sufficient.

In addition, in order to improve the flatness of the organic layer, the organic layer may contain a leveling agent. The kind of the leveling agent is not particularly limited, and a representative example is a fluorine-based leveling agent.

### Inorganic Layer

The material constituting the inorganic layer is not particularly limited, and preferably contains, for example, at least one selected from the group consisting of an oxide, a nitride, an oxynitride, a carbide, a carbonitride, a silicide, and a fluoride.

Examples of the oxide (preferably a metal oxide), the nitride (preferably a metal nitride), and the oxynitride (preferably a metal oxynitride) include an oxide, a nitride, and an oxynitride of one or more elements selected from Si, Hf, Zr, Ta, Ti, Y, Nb, Na, Co, Al, Zn, Pb, Mg, Bi, La, Ce, Pr, Sm, Eu, Gd, Dy, Er, Sr, Sn, In, and Ba. More specific examples thereof include a silicon oxynitride (SiNₓO_{y}), titanium oxide (TiO₂), indium oxide (In₂O₃), indium cerium oxide (ICO), tin oxide (SnO₂), zinc oxide (ZnO), gallium oxide (Ga₂O₃), indium tin oxide (ITO), indium zinc oxide (IZO), zinc tin oxide (ZTO), and gallium doped zinc oxide (GZO).

Examples of the carbide (preferably a metal carbide) and the carbonitride (preferably a metal carbonitride) include a carbide, a carbonitride, and a carbonate of one or more elements selected from Ti, W, Si, Zr, and Nb. For example, silicon oxycarbide (SiCO) can be used.

Note that, the carbide may be a so-called carbon material, for example, a carbide obtained by sintering a resin component such as a phenol resin.

Examples of the silicide (preferably a metal silicide) include a silicide of one or more elements selected from Mo, W, and Cr.

Examples of the fluoride (preferably a metal fluoride) include a fluoride of one or more elements selected from Mg, Y, La, and Ba. For example, magnesium fluoride (MgF₂) can be used.

A thickness of the inorganic layer is not particularly limited, and from the viewpoint of the adhesion between the substrate and the dielectric multilayer film, the thickness is preferably 5 nm to 5000 nm, and more preferably 10 nm to 500 nm.

A surface roughness (Ra) of the inorganic layer on the surface in contact with the dielectric multilayer film is preferably 2.0 nm or less, and more preferably 1.0 nm or less. The lower limit value is not particularly limited, and most preferably 0. Within the above range, the adhesion with the dielectric multilayer film is improved.

The Ra is measured according to JIS B 0601 (revised in 2001).

The adhesion layer may be a plasma-polymerized film. In the case where the adhesion layer is a plasma-polymerized film, examples of a material forming the plasma-polymerized film include fluorocarbon monomers such as CF₄, CHF₃, and CH₃F, hydrocarbon monomers such as methane, ethane, propane, ethylene, propylene, acetylene, benzene, toluene, and C₄H₈, hydrogen, and SF₆. In particular, a plasma-polymerized film made of a fluorocarbon monomer or a hydrocarbon monomer is preferred. These may be used alone or in combination of two or more kinds thereof.

From the viewpoint of scratch resistance, a thickness of the plasma-polymerized film is preferably 1 nm to 100 nm, more preferably 1 nm to 50 nm, and still more preferably 1 nm to 10 nm.

### Anti-Glare Layer and Hard Coat Layer

In the present embodiment, at least one of an anti-glare layer and a hard coat layer may be provided on the surface of the substrate on which the dielectric multilayer film is provided.

The anti-glare layer has irregularities on one surface thereof, and thereby causes external scattering or internal scattering, increasing a haze value and imparting anti-glare properties. The anti-glare layer can be those known in the related art, and may be formed of, for example, an anti-glare layer composition obtained by dispersing a particulate substance at least having anti-glare properties per se in a solution in which a polymer resin is dissolved as a binder. The anti-glare layer can be formed, for example, by coating one main surface of the substrate with the anti-glare layer composition.

Examples of the particulate substance having anti-glare properties include inorganic fine particles such as silica, clay, talc, calcium carbonate, calcium sulfate, barium sulfate, aluminum silicate, titanium oxide, synthetic zeolite, alumina, and smectite, and organic fine particles including a styrene resin, a urethane resin, a benzoguanamine resin, a silicone resin, an acrylic resin, or the like.

The hard coat layer can be those known in the related art, and may be formed of, for example, a hard coat layer composition containing a polymer resin to be described later. The hard coat layer can be formed by, for example, coating one main surface of a substrate such as a transparent substrate with the hard coat layer composition.

In addition, as the polymer resin as a binder for the anti-glare layer or the hard coat layer, for example, polymer resins such as a polyester-based resin, an acrylic resin, an acrylic urethane-based resin, a polyester acrylate-based resin, a polyurethane-based acrylate resin, an epoxy acrylate-based resin, and a urethane-based resin can be used.

### Antifouling Film

The dielectric multilayer film-attached substrate according to the present embodiment may further include an antifouling film (also referred to as an “anti finger print (AFP) film”) on the dielectric multilayer film, from the viewpoint of protecting the outermost surface of the dielectric multilayer film. The antifouling film can be formed of, for example, a fluorine-containing organosilicon compound. The fluorine-containing organosilicon compound is not particularly limited as long as it can impart an antifouling property, water repellency, and oil repellency, and examples thereof include a fluorine-containing organosilicon compound having one or more groups selected from the group consisting of a polyfluoropolyether group, a polyfluoroalkylene group, and a polyfluoroalkyl group. Note that, the polyfluoropolyether group is a divalent group having a structure in which polyfluoroalkylene groups and etheric oxygen atoms are alternately bonded.

As a commercially available fluorine-containing organosilicon compound having one or more groups selected from the group consisting of a polyfluoropolyether group, a polyfluoroalkylene group, and a polyfluoroalkyl group, KP-801 (trade name, manufactured by Shin-Etsu Chemical Co., Ltd.), KY178 (trade name, manufactured by Shin-Etsu Chemical Co., Ltd.), KY-130 (trade name, manufactured by Shin-Etsu Chemical Co., Ltd.), KY-185 (trade name, manufactured by Shin-Etsu Chemical Co., Ltd.), and Optool (registered trademark) DSX and Optool AES (trade name, all manufactured by Daikin Industries, Ltd.) can be preferably used.

In the case where the dielectric multilayer film-attached substrate according to the present embodiment includes an antifouling film, the antifouling film is provided on the dielectric multilayer film. In the case where the dielectric multilayer film is provided on both main surfaces of the substrate, the antifouling film can be formed on both the dielectric multilayer films, or the antifouling film may be laminated on only one of the main surfaces. This is because the antifouling film only needs to be provided at a part where there is a possibility of contact with human hands, and the configuration can be selected according to the application.

### Adhesive Layer

The dielectric multilayer film-attached substrate according to the present embodiment may include an adhesive layer on one of two main surfaces of a transparent substrate on which the dielectric multilayer film is not provided. The dielectric multilayer film-attached substrate is attached to, for example, an image display device via the adhesive layer. The adhesive layer can be formed by using a known adhesive composition, and examples thereof include an optical clear adhesive (OCA) and an optical clear resin (OCR) such as a UV curable resin. Examples of the OCA and the OCR include polymers such as an acrylic polymer, a silicone-based polymer, a polyester, a polyurethane, a polyamide, a polyvinyl ether, a vinyl acetate/vinyl chloride copolymer, a modified polyolefin, and rubbers such as an epoxy-based rubber, a fluorine-based rubber, a natural rubber, or a synthetic rubber. Particularly, an acrylic polymer is suitably used since it exhibits adhesive properties such as moderate wettability, cohesiveness, and adhesion, is also excellent in transparency, weather resistance, heat resistance, and solvent resistance, and has a wide range of adhesive strength.

The adhesive layer has a luminous transmittance of preferably 90% or more, more preferably 91% or more, and still more preferably 92% or more, as measured using a spectrophotometer according to the provisions in JIS Z 8709 (1999). When the transmittance of the adhesive layer is within the above range, the visibility of, for example, an image display device is not impaired.

### Luminous Reflectance: SCI Y

In the dielectric multilayer film-attached substrate according to the present embodiment, a luminous reflectance (SCI Y) of the outermost surface of the dielectric multilayer film is preferably 4% or less. When the luminous reflectance (SCI Y) is within the above range, in the case where the dielectric multilayer film-attached substrate is used in an image display device, an effect of preventing glare of external light on a screen is high. The luminous reflectance (SCI Y) is more preferably 2% or less, and particularly preferably 1% or less.

The luminous reflectance (SCI Y) can be reduced by adjusting a balance between the thicknesses of the high refractive index film layer and the low refractive index film layer to generate optical interference and suppress reflected light.

Note that, the luminous reflectance (SCI Y) is measured by the method described in Examples to be described later.

### Application

The dielectric multilayer film-attached substrate according to the present embodiment can be suitably used as an anti-reflection film for a display, a touch panel, or the like.

### Method for Producing Dielectric Multilayer Film-attached Substrate

A method for producing a dielectric multilayer film-attached substrate according to an embodiment of the present invention is a method for producing a dielectric multilayer film-attached substrate including a dielectric multilayer film, which includes a first dielectric laminated film and a second dielectric laminated film, on a substrate, and the method includes:
alternately laminating an equal number of a first high refractive index film layer containing TiO₂ and a first low refractive index film layer containing SiO₂ in this order on the substrate to form a first dielectric laminated film; and
alternately laminating an equal number of a second high refractive index film layer containing Ta₂O₅ or Nb₂O₅ and a second low refractive index film layer containing SiO₂ in this order on the first dielectric laminated film to form a second dielectric laminated film.

Each of the layers can be laminated using a known film-forming method such as a dry film-forming process such as a CVD method, a sputtering method, or a vacuum deposition method, and a wet film-forming process such as a spraying method or a dipping method. From the viewpoint of easily obtaining a high refractive index film layer with a controlled thin film layer, a dry film-forming process is preferred, and among them, a sputtering method is more preferred.

Examples of the sputtering method include methods such as magnetron sputtering, pulse sputtering, AC sputtering, and digital sputtering.

For example, the magnetron sputtering is a method in which a magnet is placed on a back surface of a base dielectric material to generate a magnetic field, and gas ion atoms collide with the surface of the dielectric material and are ejected, to form a sputtering film having a thickness of several nm, and a continuous film of a dielectric that is an oxide or a nitride of the dielectric material can be formed.

In addition, for example, the digital sputtering is a method of forming a metal oxide thin film by repeating steps of first forming a metal ultra-thin film by sputtering, and then oxidizing the film by irradiation with oxygen plasma, oxygen ions, or oxygen radicals in the same chamber, unlike a general magnetron sputtering method. In this case, since film-forming molecules are metals when deposited on a substrate, it is presumed to be more ductile than a case of depositing a metal oxide. Therefore, it is thought that even when the energy is the same, rearrangement of the film-forming molecules is likely to occur, and as a result, a dense and smooth film can be formed.

As described above, the followings are disclosed in the present description.
(1) A dielectric multilayer film-attached substrate including a substrate and a dielectric multilayer film provided on the substrate, in which
the dielectric multilayer film includes a first dielectric laminated film and a second dielectric laminated film which are laminated in this order from a substrate side,
the first dielectric laminated film includes a first high refractive index film layer containing TiO₂ and a first low refractive index film layer containing SiO₂ which are alternately laminated in this order from the substrate side with an equal number,
the second dielectric laminated film includes a second high refractive index film layer containing Ta₂O₅ or Nb₂O₅ and a second low refractive index film layer containing SiO₂ which are alternately laminated in this order from the substrate side with an equal number, and
a first low refractive index film layer located farthest from the substrate in the first dielectric laminated film has a thickness of 30 nm or more.
(2) The dielectric multilayer film-attached substrate according to the above (1), in which a ratio (T1/T2) is 0.7 or more and 1.4 or less, provided that T1 is a thickness of a first high refractive index film layer located farthest from the substrate in the first dielectric laminated film and T2 is a thickness of a second high refractive index film layer located closest to the substrate side in the second dielectric laminated film.
(3) The dielectric multilayer film-attached substrate according to the above (1) or (2), in which the dielectric multilayer film has a total thickness of 300 nm or less.
(4) The dielectric multilayer film-attached substrate according to any one of the above (1) to (3), in which a second low refractive index film layer located farthest from the substrate in the second dielectric laminated film has a thickness of 75 nm or more and 105 nm or less.
(5) The dielectric multilayer film-attached substrate according to any one of the above (1) to (4), in which a total number of layers of the first high refractive index film layer, the first low refractive index film layer, the second high refractive index film layer, and the second low refractive index film layer in the dielectric multilayer film is 6 or more and 12 or less.
(6) The dielectric multilayer film-attached substrate according to the above (5), in which the total number of layers is 6.
(7) The dielectric multilayer film-attached substrate according to the above (6), in which the dielectric multilayer film includes, from the substrate side:
a first high refractive index film layer a1 containing TiO₂;
a first low refractive index film layer b1 containing SiO₂;
a first high refractive index film layer a2 containing TiO₂;
a first low refractive index film layer b2 containing SiO₂;
a second high refractive index film layer a3 containing Ta₂O₅ or Nb₂O₅; and
a second low refractive index film layer b3 containing SiO₂.
(8) The dielectric multilayer film-attached substrate according to the above (6), in which the dielectric multilayer film includes, from the substrate side:
a first high refractive index film layer a1 containing TiO₂ and having a thickness of 20 nm or less;
a first low refractive index film layer b1 containing SiO₂ and having a thickness of 30 nm or more and 50 nm or less;
a first high refractive index film layer a2 containing TiO₂ and having a thickness of 10 nm or more and 50 nm or less;
a first low refractive index film layer b2 containing SiO₂ and having a thickness of 30 nm or more and 50 nm or less;
a second high refractive index film layer a3 containing Ta₂O₅ or Nb₂O₅ and having a thickness of 15 nm or more and 50 nm or less; and
a second low refractive index film layer b3 containing SiO₂ and having a thickness of 75 nm or more and 105 nm or less.
(9) The dielectric multilayer film-attached substrate according to any one of the above (1) to (8), in which the substrate includes at least one of a glass and a resin.
(10) The dielectric multilayer film-attached substrate according to any one of the above (1) to (9), further including an adhesion layer between the substrate and the dielectric multilayer film.
(11) A method for producing a dielectric multilayer film-attached substrate,
a dielectric multilayer film-attached substrate including:
a substrate; and
a dielectric multilayer film provided on the substrate and including a first dielectric laminated film and a second dielectric laminated film,
the method including:
alternately laminating an equal number of a first high refractive index film layer containing TiO₂ and a first low refractive index film layer containing SiO₂ in this order on the substrate to form a first dielectric laminated film; and
alternately laminating an equal number of a second high refractive index film layer containing Ta₂O₅ or Nb₂O₅ and a second low refractive index film layer containing SiO₂ in this order on the first dielectric laminated film to form a second dielectric laminated film, in which
a first low refractive index film layer located farthest from the substrate in the first dielectric laminated film has a thickness of 30 nm or more.

### EXAMPLES

Hereinafter, the present invention is described in detail with reference to Examples, but the present invention is not limited thereto. Example 1 to Example 3 are Inventive Examples, and Example 4 to Example 8 are Comparative Examples.

### Thickness Measurement

The film thickness was determined by measuring a reflectance at each wavelength using a spectrophotometer (trade name: SolidSpec3700 manufactured by Shimadzu Corporation) and using TF-Calc (manufactured by HULINKS Inc.) with a refractive index dispersion and the film thickness as variables from the actual reflection spectrum obtained.

### Film Stress Measurement

The film stress was calculated based on a change in amount of warpage before and after the film formation measured by the following method, using the following Stoney Equation.

### Change in Amount of Warpage before and After Film Formation

A Dyvoce 3000 laser displacement meter manufactured by Kohzu Precision Co.,Ltd. was used to measure height positions of outer and inner peripheral sides of the substrate, and the difference was calculated as the amount of warpage. The amount of warpage was measured before and after the film formation, and the difference was determined as the contribution of the residual stress due to the film formation.

$$\begin{matrix}( Stoney Equation ) & \\ Film stress = {ED}^{2} / 6 ( 1 - v ) tR & \end{matrix}$$

$$E = Young ' s modulus of substrate$$

$$v = Poisson ' s ratio of substrate$$

$$D = thickness of substrate$$

$$t = film thickness$$

$$R = radius curvature change$$

### Luminous Reflectance (SCI Y)

The luminous reflectance (SCI Y) was measured by measuring the luminous reflectance of the outermost surface of the dielectric multilayer film using a spectrophotometer (trade name: SolidSpec3700 manufactured by Shimadzu Corporation) according to the method specified in JIS Z 8722 (2009).

### Example 1

A dielectric multilayer film-attached substrate in Example 1 was prepared by using the following method. The dielectric multilayer film-attached substrate in Example 1 has a layer configuration shown in FIG. 2. That is, the dielectric multilayer film-attached substrate 2 was formed by laminating the first dielectric laminated film 10 and the second dielectric laminated film 20 in this order on the substrate S.

The first dielectric laminated film 10 was formed by laminating the first high refractive index film layer a1 containing TiO₂, the first low refractive index film layer b1 containing SiO₂, the first high refractive index film layer a2 containing TiO₂, and the first low refractive index film layer b2 containing SiO₂ in this order from the substrate S side. The second dielectric laminated film 20 was formed by laminating the second high refractive index film layer a3 containing Ta₂O₅ and the second low refractive index film layer b3 containing SiO₂ in this order from the substrate S side. The dielectric multilayer film-attached substrate 2 in Example 1 has a dielectric laminated film having a total of six layers provided on the substrate S.

The details is described below.

As the substrate S, a quartz substrate (synthetic recycled material, manufactured by SAN-EI Optical Co., Ltd.) having a refractive index of 1.46 and a diameter of 150 mm and a thickness of 0.5 mm was used.

Sufficient vacuum evacuation was performed, and reactive sputtering using a DC magnetron and an oxygen gas was performed under conditions of a pre-evacuation pressure of 10⁻⁴ Pa or less and an Ar gas pressure atmosphere of 0.1 Pa during film formation, to form the first high refractive index film layer a1 containing TiO₂ having a thickness of 10 nm on the quartz substrate.

Subsequently, sufficient vacuum evacuation was performed, and reactive sputtering using a DC magnetron and an oxygen gas was performed under conditions of a pre-evacuation pressure of 10⁻⁴ Pa or less and an Ar gas pressure atmosphere of 0.1 Pa during film formation, to form the first low refractive index film layer b1 containing SiO₂ having a thickness of 40 nm on the first high refractive index film layer a1.

Subsequently, sufficient vacuum evacuation was performed, and reactive sputtering using a DC magnetron and an oxygen gas was performed under conditions of a pre-evacuation pressure of 10⁻⁴ Pa or less and an Ar gas pressure atmosphere of 0.1 Pa during film formation, to form the first high refractive index film layer a2 containing TiO₂ having a thickness of 30 nm on the first low refractive index film layer b1.

Subsequently, sufficient vacuum evacuation was performed, and reactive sputtering using a DC magnetron and an oxygen gas was performed under conditions of a pre-evacuation pressure of 10⁻⁴ Pa or less and an Ar gas pressure atmosphere of 0.1 Pa during film formation, to form the first low refractive index film layer b2 containing SiO₂ having a thickness of 30 nm on the first high refractive index film layer a2.

In this way, the first dielectric laminated film 10 was formed.

Next, sufficient vacuum evacuation was performed, and reactive sputtering using a DC magnetron and an oxygen gas was performed under conditions of a pre-evacuation pressure of 10⁻⁴ Pa or less and an Ar gas pressure atmosphere of 0.1 Pa during film formation, to form the second high refractive index film layer a3 containing Ta₂O₅ having a thickness of 30 nm on the first low refractive index film layer b2 of the first dielectric laminated film 10.

Subsequently, sufficient vacuum evacuation was performed, and reactive sputtering using a DC magnetron and an oxygen gas was performed under conditions of a pre-evacuation pressure of 10⁻⁴ Pa or less and an Ar gas pressure atmosphere of 0.1 Pa during film formation, to form the second low refractive index film layer b3 containing SiO₂ having a thickness of 85 nm on the second high refractive index film layer a3.

In this way, the second dielectric laminated film 20 was formed on the first dielectric laminated film 10, and thus the dielectric multilayer film-attached substrate in Example 1 was prepared.

### Example 2 to Example 8

Example 1 was repeated except that unlike in Example 1, the layer configuration and the thickness of the dielectric multilayer film were changed as shown in Table 1.

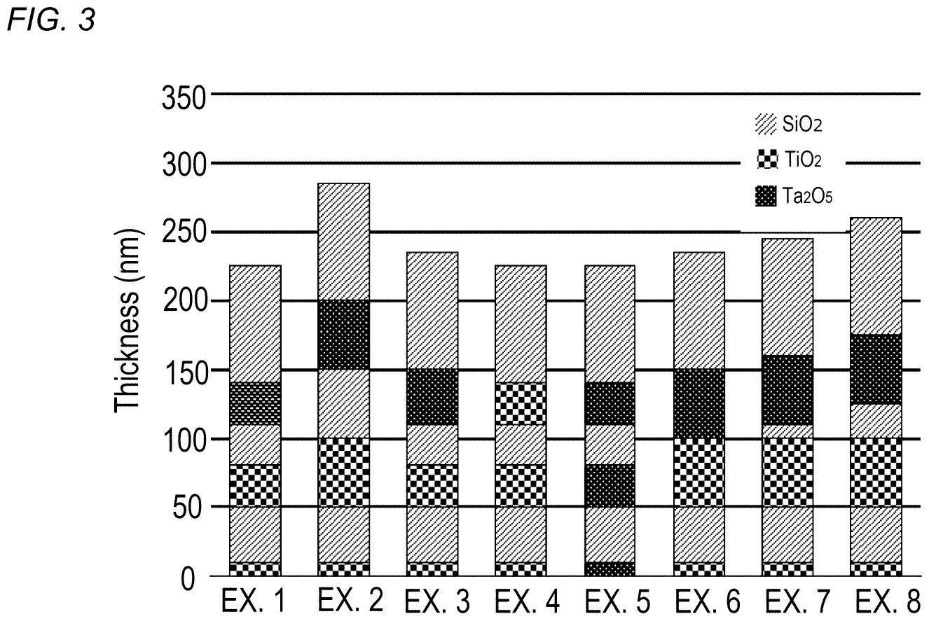

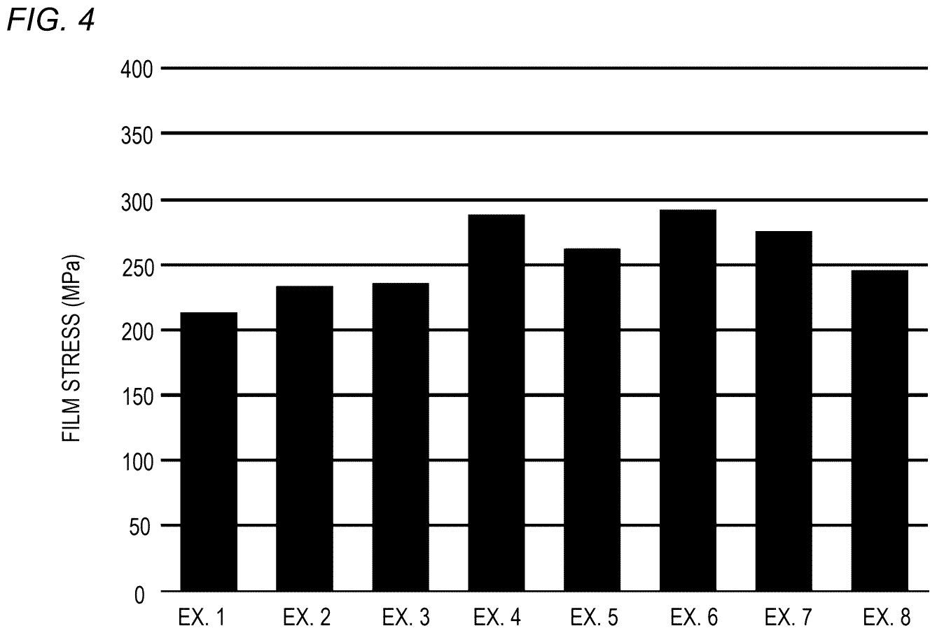

The results are shown in Table 1. FIG. 3 shows the thickness of the dielectric multilayer film, and FIG. 4 shows the measurement results of the film stress.

TABLE 1

| | Ex. 1 | Ex. 2 | Ex. 3 | Ex. 4 | Ex. 5 | Ex. 6 | Ex. 7 | Ex. 8 |
|---|---|---|---|---|---|---|---|---|
| Substrate | Quartz | Quartz | Quartz | Quartz | Quartz | Quartz | Quartz | Quartz |
| First high | 10 nm, TiO₂ | 10 nm, TiO₂ | 10 nm, TiO₂ | 10 nm, TiO₂ | 10 nm, Ta₂O₅ | 10 nm, TiO₂ | 10 nm, TiO₂ | 10 nm, TiO₂ |
| refractive index | | | | | | | | |
| film layer a1 | | | | | | | | |
| (thickness, kind) | | | | | | | | |
| First low | 40 nm, SiO₂ | 40 nm, SiO₂ | 40 nm, SiO₂ | 40 nm, SiO₂ | 40 nm, SiO₂ | 40 nm, SiO₂ | 40 nm, SiO₂ | 40 nm, SiO₂ |
| refractive index | | | | | | | | |
| film layer b1 | | | | | | | | |
| (thickness, kind) | | | | | | | | |
| First high | 30 nm, TiO₂ | 50 nm, TiO₂ | 30 nm, TiO₂ | 30 nm, TiO₂ | 30 nm, Ta₂O₅ | 50 nm, TiO₂ | 50 nm, TiO₂ | 50 nm, TiO₂ |
| refractive index | | | | | | | | |
| film layer a2 | | | | | | | | |
| (thickness, kind) | | | | | | | | |
| First low | 30 nm, SiO₂ | 50 nm, SiO₂ | 30 nm, SiO₂ | 30 nm, SiO₂ | 30 nm, SiO₂ | — | 10 nm, SiO₂ | 25 nm, SiO₂ |
| refractive index | | | | | | | | |
| film layer b2 | | | | | | | | |
| (thickness, kind) | | | | | | | | |
| Second high | 30 nm, Ta₂O₅ | 50 nm, Ta₂O₅ | 40 nm, Ta₂O₅ | 30 nm, TiO₂ | 30 nm, Ta₂O₅ | 50 nm, Ta₂O₅ | 50 nm, Ta₂O₅ | 50 nm, Ta₂O₅ |
| refractive index | | | | | | | | |
| film layer a3 | | | | | | | | |
| (thickness, kind) | | | | | | | | |
| Second low | 85 nm, SiO₂ | 85 nm, SiO₂ | 85 nm, SiO₂ | 85 nm, SiO₂ | 85 nm, SiO₂ | 85 nm, SiO₂ | 85 nm, SiO₂ | 85 nm, SiO₂ |
| refractive index | | | | | | | | |
| film layer b3 | | | | | | | | |
| (thickness, kind) | | | | | | | | |
| Total thickness | 225 nm | 285 nm | 235 nm | 225 nm | 225 nm | 235 nm | 245 nm | 260 nm |
| T1/T2 | 1 | 1 | 0.75 | 1 | 1 | 1 | 1 | 1 |
| (a2 thickness/a3 | | | | | | | | |
| thickness) | | | | | | | | |
| Film stress (MPa) | 213 | 233 | 235 | 288 | 262 | 291 | 276 | 266 |
| Luminous | 1.0 | 19.0 | 1.9 | 1.3 | 1.2 | 1.0 | 1.6 | 6.2 |
| reflectance Y | | | | | | | | |

As seen from the results in Table 1, the dielectric multilayer film-attached substrates in Example 1 to Example 3 are formed by laminating the first dielectric laminated film and the second dielectric laminated film in this order on the substrate, in which the first dielectric laminated film is formed by alternately laminating the first high refractive index film layer containing TiO₂ and the first low refractive index film layer containing SiO₂ in this order from the substrate side, the first dielectric laminated film has an equal number of the first high refractive index film layer and the first low refractive index film layer, the second dielectric laminated film is formed by alternately laminating the second high refractive index film layer containing Ta₂O₅ or Nb₂O₅ and the second low refractive index film layer containing SiO₂ in this order from the substrate S side, the second dielectric laminated film has an equal number of the second high refractive index film layer and the second low refractive index film layer, and the first low refractive index film layer located farthest from the substrate in the first dielectric laminated film has a thickness of 30 nm or more, so that the film stress is reduced, and warpage and peeling can be sufficiently prevented.

On the other hand, in Example 4, the second high refractive index film layer containing Ta₂O₅ or Nb₂O₅ is not formed, so that the film stress is increased.

In Example 5, the first high refractive index film layer containing TiO₂ is not formed, so that the film stress is increased.

In Example 6, the first low refractive index film layer is not formed on the side located farthest from the substrate in the first dielectric laminated film, so that the film stress is increased.

In Example 7 and Example 8, the thickness of the first low refractive index film layer located farthest from the substrate is less than 30 nm, so that the film stress is increased.

Although various embodiments have been described above with reference to the Figures, it is needless to say that the present invention is not limited to such examples. It is obvious for a person skilled in the art that various modifications and variations can be made within the range described in the scope of claims and it is understood that such modifications and variations naturally belong to the technical scope of the present invention. Further, the components described in the above embodiment may be combined in any manner without departing from the spirit of the invention.

The present application is based on a Japanese Patent Application (No. 2022-133627) filed on Aug. 24, 2022, contents of which are incorporated herein by reference.

### REFERENCE SIGNS LIST

1, 2: dielectric multilayer film-attached substrate
10: first dielectric laminated film
20: second dielectric laminated film
101, a1, a2: first high refractive index film layer containing TiO₂
102, b1, b2: first low refractive index film layer containing SiO₂
201, a3: second high refractive index film layer containing Ta₂O₅ or Nb₂O₅
202, b3: second low refractive index film layer containing SiO₂
S: substrate

1. A dielectric multilayer film-attached substrate comprising a substrate and a dielectric multilayer film provided on the substrate, wherein
the dielectric multilayer film comprises a first dielectric laminated film and a second dielectric laminated film which are laminated in this order from a substrate side,
the first dielectric laminated film comprises a first high refractive index film layer containing TiO₂ and a first low refractive index film layer containing SiO₂ which are alternately laminated in this order from the substrate side with an equal number,
the second dielectric laminated film comprises a second high refractive index film layer containing Ta₂O₅ or Nb₂O₅ and a second low refractive index film layer containing SiO₂ which are alternately laminated in this order from the substrate side with an equal number, and
a first low refractive index film layer located farthest from the substrate in the first dielectric laminated film has a thickness of 30 nm or more.

2. The dielectric multilayer film-attached substrate according to claim 1, wherein a ratio (T1/T2) is 0.7 or more and 1.4 or less, provided that T1 is a thickness of a first high refractive index film layer located farthest from the substrate in the first dielectric laminated film and T2 is a thickness of a second high refractive index film layer located closest to the substrate side in the second dielectric laminated film.

3. The dielectric multilayer film-attached substrate according to claim 1, wherein the dielectric multilayer film has a total thickness of 300 nm or less.

4. The dielectric multilayer film-attached substrate according to claim 1, wherein a second low refractive index film layer located farthest from the substrate in the second dielectric laminated film has a thickness of 75 nm or more and 105 nm or less.

5. The dielectric multilayer film-attached substrate according to claim 1, wherein a total number of layers of the first high refractive index film layer, the first low refractive index film layer, the second high refractive index film layer, and the second low refractive index film layer in the dielectric multilayer film is 6 or more and 12 or less.

6. The dielectric multilayer film-attached substrate according to claim 5, wherein the total number of layers is 6.

7. The dielectric multilayer film-attached substrate according to claim 6, wherein the dielectric multilayer film comprises, from the substrate side:
a first high refractive index film layer a1 containing TiO₂;
a first low refractive index film layer b1 containing SiO₂;
a first high refractive index film layer a2 containing TiO₂;
a first low refractive index film layer b2 containing SiO₂;
a second high refractive index film layer a3 containing Ta₂O₅ or Nb₂O₅; and
a second low refractive index film layer b3 containing SiO₂.

8. The dielectric multilayer film-attached substrate according to claim 6, wherein the dielectric multilayer film comprises, from the substrate side:
a first high refractive index film layer a1 containing TiO₂ and having a thickness of 20 nm or less;
a first low refractive index film layer b1 containing SiO₂ and having a thickness of 30 nm or more and 50 nm or less;
a first high refractive index film layer a2 containing TiO₂ and having a thickness of 10 nm or more and 50 nm or less;
a first low refractive index film layer b2 containing SiO₂ and having a thickness of 30 nm or more and 50 nm or less;
a second high refractive index film layer a3 containing Ta₂O₅ or Nb₂O₅ and having a thickness of 15 nm or more and 50 nm or less; and
a second low refractive index film layer b3 containing SiO₂ and having a thickness of 75 nm or more and 105 nm or less.

9. The dielectric multilayer film-attached substrate according to claim 1, wherein the substrate comprises at least one of a glass and a resin.

10. The dielectric multilayer film-attached substrate according to claim 1, further comprising an adhesion layer between the substrate and the dielectric multilayer film.

11. A method for producing a dielectric multilayer film-attached substrate,
a dielectric multilayer film-attached substrate comprising:
a substrate; and
a dielectric multilayer film provided on the substrate and comprising a first dielectric laminated film and a second dielectric laminated film,
the method comprising:
alternately laminating an equal number of a first high refractive index film layer containing TiO₂ and a first low refractive index film layer containing SiO₂ in this order on the substrate to form a first dielectric laminated film; and
alternately laminating an equal number of a second high refractive index film layer containing Ta₂O₅ or Nb₂O₅ and a second low refractive index film layer containing SiO₂ in this order on the first dielectric laminated film to form a second dielectric laminated film, wherein
a first low refractive index film layer located farthest from the substrate in the first dielectric laminated film has a thickness of 30 nm or more.
